(19) United States
(12) Patent Application Publication
(10) Pub. No.: US 2021/0098153 A1
(43) Pub. Date: Apr. 1, 2021

(54) FIRE RESISTANT CABLE

(71) Applicant: Champlain Cable Corp., Colchester, VT (US)

(72) Inventor: Tariq Quadir, Colchester, VT (US)

(73) Assignee: Champlain Cable Corp., Colchester, VT (US)

(21) Appl. No.: 17/037,083

(22) Filed: Sep. 29, 2020

Related U.S. Application Data
(60) Provisional application No. 62/908,019, filed on Sep. 30, 2019.

(51) Int. Cl. H01B 7/295; H01B 7/29; H01B 3/12; H01B 3/10; H01B 7/02

(52) U.S. Cl. CPC H01B 7/295; H01B 7/292; H01B 7/0266; H01B 3/105; H01B 3/12

(57) ABSTRACT

A fire resistant cable, the cable includes an electrical conductor surrounded by an insulation layer. The insulation layer is a composite material including ceramic particles embedded in a polymer matrix. The ceramic particles and polymers are chosen such that the ceramic particles start to sinter together at a temperature lower than the complete decomposition of the polymer chains. When the cable is exposed to heat and flame the polymer degrades, the ceramic particles sinter together and the insulation layer becomes a continuous sintered ceramic layer that both insulates and supports the conductor for improved circuit integrity.

### CROSS-REFERENCE TO RELATED APPLICATIONS

This disclosure claims the benefit of priority of U.S. Provisional Patent Application No. 62/908,019, filed Sep. 30, 2019, which is herein incorporated by reference.

### FIELD

The present invention generally relates to electrical cables. More specifically, the invention relates to cables that include an electrical conductor and an insulation layer. Still more specifically, in this invention the insulation layer protects the electrical conductor when exposed to fire to maintain circuit integrity.

### BACKGROUND

Generally wires and cables have insulation to both add structural integrity to the electrical conductor and protect the electrical conductor from environmental factors such as water, chemicals, abrasion, contact with humans, etc. One specific environmental factor is the direct exposure to fire. Cellulose fueled fires typically reach over 500° C. in 5 minutes and 700° in 10 minutes. Petroleum pool fueled fires have a much faster temperature rise. Both examples will typically reach temperatures in excess of 1000° C. Most common wire and cable insulation types used today oxidize (decompose) at temperatures above 300° C., resulting in exposing copper conductors, diffusion bonding and subsequently oxidizing the copper conductors. This sequence of thermal events results in the loss of circuit integrity. Circuit integrity (CI) is defined as the ability of an electrical cable to continue to operate in its intended function while exposed directly to fire and other adverse conditions.

In certain fire events, such as high-rise buildings, oil platforms, mining, etc.; continued transmission of electrical power and signals through critical circuits via the cables is crucial for evacuation of occupants, communications between emergency responders, continuous operation of ventilation systems, and continuous operation of firefighting equipment. In such emergencies, time is of the essence. Therefore extending the circuit integrity from less than 5 minutes to several hours can mean the difference between life and death or fire containment versus total destruction. UL (Underwriters Laboratories) standards for wire/circuit integrity safety are defined in UL 1424 “Cables for Power-Limited Fire-Alai Circuits” and UL 1581 “Reference Standard for Electrical Wires, Cables, and Flexible Cords”, both of these documents of which are herein incorporated by reference. National codes and standards for circuit integrity cables are defined in NFPA 72, NEC 760, NFPA 130, and NFPA 502.

There are essentially two types of circuit integrity cables available today. One type is constructed using “ceramifiable” polymeric compounds as the insulation layer. These ceramifiable compounds are typically a blend of silicone rubber polymer and additives that upon exposure to intense heat oxidize and then sinter into a ceramic layer. Another type of cable is Mineral Insulated (MI), which consists of a continuous corrugated metallic tube containing bare conductors surrounded by insulative inorganic mineral. In this type of cable, there are no organic materials and the cable is inherently resistant to fire.

Typical wire and cable insulations contain flame retardants in the insulating layer. Flame retardant's role in plastic industry is to minimize propagation of flame in fuel rich environment such as plastics. The flame formed by any source (electrical, ignition, overheating) can propagate very quickly in the presence of oxygen. Therefore, flame retardants that incorporate brominated and chlorinated compounds are commonly used in the plastic industries. These flame retardants are classified as halogenated. The issue with halogen based flame retardants is that during the fire they emit toxic and corrosive acid gases such as HCL and HBR, which are lethal at low concentration, putting occupants and emergency responders at risk. As a solution to this issue, many insulation systems contain non-halogenated flame retardants. These non-halogen flame retardants typically are composed of aluminum trihydrate (ATH) and magnesium hydroxide, which release water when subjected to intense heat.

The integrity of critical circuits during a catastrophic event is essential to minimizing loss of life and property. Standards for such cables are provided through Underwriters Laboratories (UL). Standard testing under UL 2196 “Fire Test for Circuit Integrity of Fire-Resistive Power, Instrumentation, Control and Data Cables” evaluates the ability of circuit integrity cables to continue to operate when subjected to fire conditions. The UL 2196 document is herein incorporated by reference. The UL 2196 standard represents typical worst case fire conditions over a period of time that represents complete evacuation time requirements.

Given what presently is available for circuit integrity cables, it is clear that there is opportunity for the production of cables that have a lower cost structure, easier installation characteristics and improved circuit integrity of the wire during exposure to fire. The main objective of the present invention is to have the electrical conductor protected from intense heat so it can transmit power and signals over critical circuits in an emergency for an extended period to time.

### SUMMARY

In one implementation, the present disclosure is directed to a circuit integrity electrical cable. The cable comprises an electrical conductor and an insulation layer. The insulation layer is a composite material including ceramic particles in a polymer matrix. The ceramic particles sinter when exposed to a fire at a temperature lower than the decomposition of the polymer.

In another implementation, the present disclosure is directed to a fire resistant material. The fire resistant material is comprised of ceramic particles with the remainder of the material being substantially a polymer. The ceramic particles sinter when exposed to fire at a temperature lower than the decomposition of the polymer.

In yet another implementation, the present disclosure is directed to a fire resistant electrical cable. The cable comprises an electrical conductor and an insulation layer. The insulation layer is a composite material including ceramic particles in a polymer matrix. The insulation layer is surrounded by a woven glass fiber tape. The woven glass tape is surrounded by a polymer jacket. The ceramic particles sinter when exposed to fire at a temperature lower than the decomposition of the polymer.

In yet another implementation, the present disclosure is directed to a method of extending the circuit integrity of an electrical conductor. The method comprises providing an electrical conductor. The method then involves surrounding the electrical conductor with an insulation layer that includes ceramic particles within a polymeric compound. Upon exposure to a fire the ceramic particles start sintering prior to complete decomposition of the polymer forming a continuous structure of sintered ceramic that thermally insulates and supports the electrical conductor.

In still yet another implementation, the present disclosure is directed to a fire resistant electrical cable. The fire resistant cable comprises an electrical conductor and a braided layer of alumina-silica filament woven around the metal conductor.

### BRIEF DESCRIPTION OF DRAWINGS

For the purposes of illustrating the invention, the drawings show aspects of one or more embodiments of the invention. However, it should be understood that the present invention is not limited to the precise arrangements and instrumentalities shown in the drawings, wherein:

FIG. 1 is a partial cut away, perspective view of one embodiment of a fire resistant cable in accordance with the present invention;

FIG. 2 is a sectional view along line 2-2 of FIG. 1;

FIG. 3 is a partial cut away, perspective view of another embodiment of a fire resistant cable in accordance with the present invention;

FIG. 4 is a sectional view along line 4-4 of FIG. 3;

FIG. 5 is a partial cut away, perspective view of another embodiment of a fire resistant cable in accordance with the present invention;

FIG. 6 is a sectional view along line 6-6 of FIG. 5;

FIG. 7 is partial cut away, perspective view of another embodiment of a fire resistant cable in accordance with the present invention;

FIG. 8 is a sectional view along line 8-8 of FIG. 7;

FIG. 9 is partial cut away, perspective view of another embodiment of a fire resistant cable in accordance with the present invention;

FIG. 10 is a sectional view along line 10-10 of FIG. 9;

FIG. 11a is a schematic representation of one exemplary embodiment of a insulation material used in accordance with the fire resistant cables in FIGS. 1-8, the schematic depicting a mixture of crystalline inorganic particles, glass particles and a polymer;

FIG. 11b is a schematic representation of the sintered ceramic body resulting after exposing the insulation material depicted in FIG. 11a to a fire, the resulting structure having particles of ceramic bonded by glass;

FIG. 12a is a schematic representation of one exemplary embodiment of an insulation material in accordance with the fire resistant cables in FIGS. 1-8, the schematic depicting a mixture of glass-ceramic particles and a polymer;

FIG. 12b is a schematic representation of the sintered ceramic body resulting after exposing the insulation material depicted in FIG. 12a to a fire, the resulting structure having glass-ceramic particles bonded together;

FIG. 13a is a schematic representation of one exemplary embodiment of an insulation material in accordance with the fire resistant cables in FIGS. 1-8, the schematic depicting a mixture of glass particles and a polymer;

FIG. 13b is a schematic representation of the sintered ceramic body resulting after exposing the insulation material depicted in FIG. 13a to a fire, the resulting structure having glass particles bonded together;

FIG. 14a is a schematic representation of one exemplary embodiment of an insulation material in accordance with the fire resistant cables in FIGS. 1-8, the schematic depicting a mixture of glass particles and a polymer;

FIG. 14b is a schematic representation of the sintered ceramic body resulting after exposing the insulation material depicted in FIG. 14a to a fire, the resulting structure having glass/crystalline particles bonded together;

FIG. 15 is a graph illustrating densification of ceramic versus polymer decomposition as applied to the fire resistant cables shown in FIGS. 1-8 and insulation materials shown in FIGS. 11a-14b;

FIG. 16 is a graph illustrating bonding versus percent glass as applied to the fire resistant cables shown in FIGS. 1-8 and insulation materials shown in FIGS. 11a-14b;

FIG. 17 is a graph illustrating particle bonding versus softening temperature as applied to the fire resistant cable shown in FIGS. 1-8 and insulation materials shown in FIGS. 11a-14b;

FIG. 18 is a graph illustrating a standard safety test temperature excursion that the fire resistant cables shown in FIGS. 1-8 should be able to hold up to; and

FIG. 19 is a schematic representation of a circuit integrity test setup used to show the efficacy of the new invention.

### DETAILED DESCRIPTION

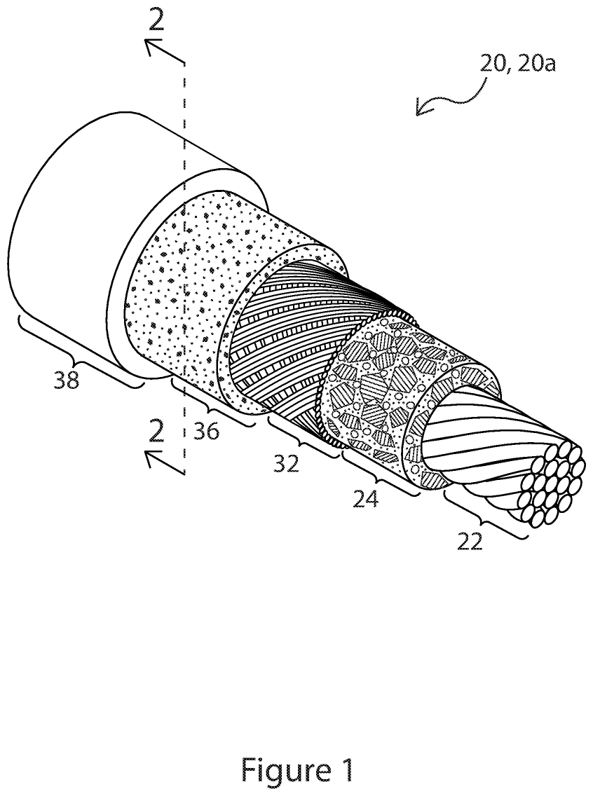

Fire resistant cables 20 (20a, 20b, 20c, 20d and 20e) and the physical attributes of the insulating materials used in fabricating these cables are illustrated in FIGS. 1-17. Generally a “wire” is a single conductor, while a “cable” is two or more insulated wires wrapped in one jacket. Multiple conductors that have no insulation around the conductors would be classified as a single conductor. For purposes of this disclosure the term “cable” is being used more broadly to cover both “wires” and “cables” as the invention may be applied to both single wire conductors and multiple insulated wires wrapped in a jacket.

Fire resistant cable 20 comprises an electrical conductor 22. Electrical conductor 22 may be any metal such as copper, nickel, silver, steel, aluminum, etc. Electrical conductor 22 is generally a wire, i.e. a conductor in an elongated form. Electrical conductor 22 may be a single solid piece of material or a plurality of conductors stranded together. Fire resistant cable 20 further comprises an insulation layer 24 to protect the cable from exposure to a fire. Although insulation material 24 is disclosed as being applied to an elongated conductor, it is understood that the insulation material may be applied to conductors of any shape without departing from the scope of the invention.

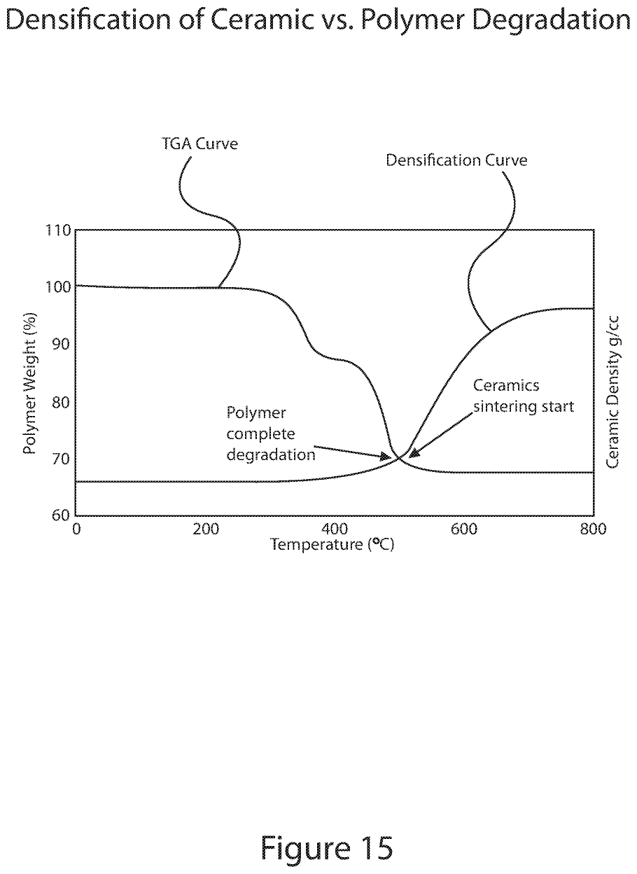

In one embodiment, insulation layer 24 is a composite material that includes ceramic particles 25 (25a, 25b, 25c) embedded in a polymer 28. Polymer 28 is comprised of polymer chains. Polymer 28 is usually provided in the form of a polymer matrix 30 with ceramic particles embedded within. The polymer and ceramic are chosen such that when exposed to flame and heat the ceramic particles start to sinter together at a temperature lower than the complete decomposition of the polymer chains. Generally the sintering temperature for ceramic 25 is in the range of 500° C. to 600° C. The complete decomposition of the polymer chains is defined as to when there is no more weight loss upon heating, i.e. there is no more breaking down of the polymer chains into volatile components with continued exposure to heat. Complete decomposition of the polymer chains can be measured using a Thermo Gravimetric Analysis (TGA) curve of the polymer, FIG. 15. It is also critical to have the polymer not burn off too quickly, before the softening temperature has been reached for the ceramic particles. If this happens, the insulating layer 24 may fall off before any sintering has occurred within the ceramic. Having ceramic particles 25 start to sinter and bond together before the polymer degrades allows for a continuous, intact insulation ceramic material to be formed around the conductor prior to the polymer falling apart. In this manner, conductor 22 is both structurally supported and insulated from the fire's heat by insulation layer 24 providing more time for cable 20 to maintain circuit integrity.

The materials and structure provide in the present invention provides advantages over other insulating materials on the market today. For example, in the siloxane based system discussed earlier, oxidation takes place with heat at 500° C. to 600° C. in air and the silicone turns into SiO2 (Si+O2-→SiO2) powder. The SiO2 powder may not sinter efficiently below 1000° C. In present invention the composite composition with a glass having a Tg (glass transition temperature) of around 500° C. or glass/glass-ceramics with softening around 550° C.-650° C. allows sintering between ceramic particles to start prior to the polymer holding the ceramics together completely decomposing. The result is an insulation material that provides a structural ceramic to support the integrity of the cable from 500° C. to 1000° C. and above.

In another embodiment, insulation layer 24 can be a braided insulation layer 32 such as alumina silica fiber. Generally alumina silica fibers 32 are woven in various patterns. Typical coverage of the woven fibers is 40-70 percent by area. The woven fibers provide both structural support and thermal insulation. Braided alumina silica fiber 32 may be used in conjunction with any of the insulation layers 24 disclosed that includes ceramic particles 25 embedded in a polymer matrix 30.

In some embodiments, additional layers may be used in conjunction with insulation layer 24 to further enhance the fire resistance properties and other structural attributes of cable 20. Fillers 34 may be incorporated to fill empty spaces around multiple wires 35 (a.k.a. primaries) being packaged together to form a more uniformly shaped, cylindrical cable. Fillers 34 may be polypropylene fibers, flame retardant fibers, insulating fibers, extruded strands of various compounds, or any other material that conforms to the extrusion temperatures of the jacket material. Fillers 34 in general cable manufacturing provides symmetry and roundness to the cable. In the present invention, the fillers additionally may provide flame retardant and insulation properties. A bedding layer 36 may also be incorporated to enhance symmetry and roundness as well as provide additional flame retardant and insulation properties. Bedding layer 36 may be any one of the flame retardant layers commercially available on the market or a specifically formulated flame retardant layer. A braided abrasion layer 37 may be incorporated to enhance the abrasion resistance of the cable. Such a layer may be made of wire or ceramic. A char forming layer may be incorporated to further limit burning. The char forming layer, when exposed to a flame, instead of completely oxidizing the layer it forms a carbonatious residual that slows down the reactivity of the polymer with oxygen. An outer jacket 38 may be incorporated to provide for surface aesthetics. Outer jacket 38 may also provide flame retardant and insulative properties. The exact combination of the aforementioned layers depends on the specific application needs. Together these layers combine for optimal thermal performance with several embodiments illustrated below.

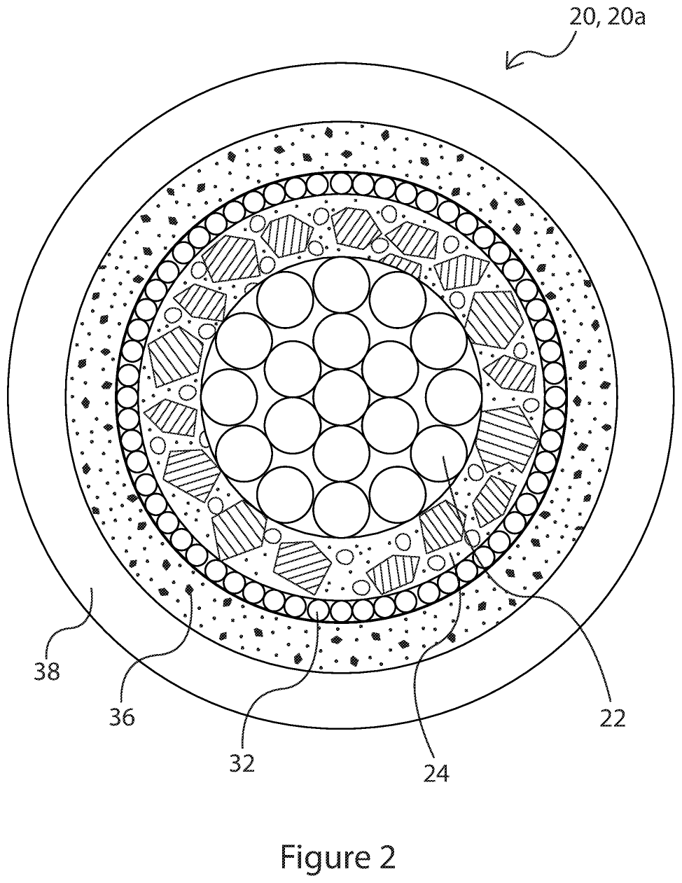

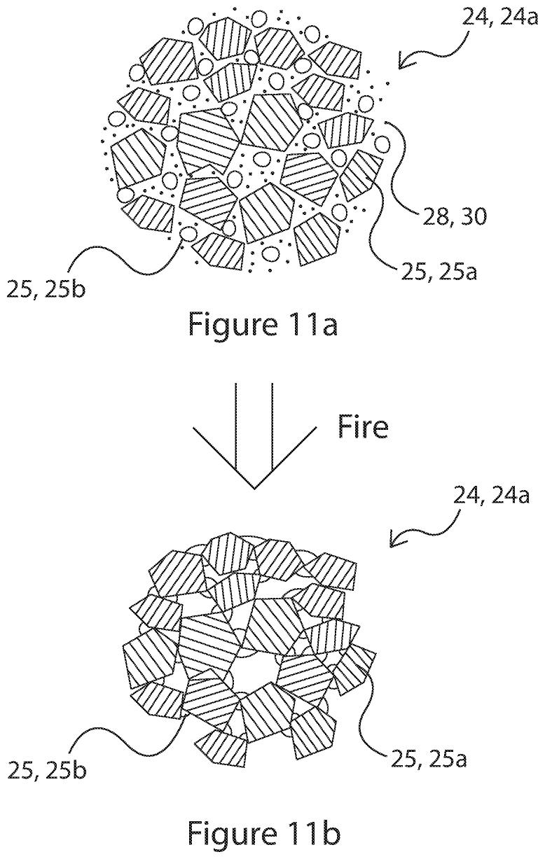

In FIGS. 1 and 2 fire resistant cable 20, 20a is a single wire. Cable 20a comprises a conductor 22. Metal conductor 22 may have a plurality of conductors 22 twisted together. Metal conductor 22 could also be a single, solid conductor. Cable 20a further comprises insulation layer 24 surrounding conductor 22. Insulation layer 24 may be any of the insulation layers shown in FIGS. 11a-14b and discussed below. Insulation layer is a composite material including ceramic particles 25 in a polymer matrix 30, where the ceramic particles start to sinter together at a temperature lower than the complete decomposition of the polymer chains. Cable 20a may further include a braided insulation layer 32. Cable 20a may further include a fire retardant layer 36. Cable 20a may also include an outer jacket 38. Although the layers are shown in a preferred order for FIGS. 1 and 2, the order, number and type of the layers may be changed without departing from the scope of the invention.

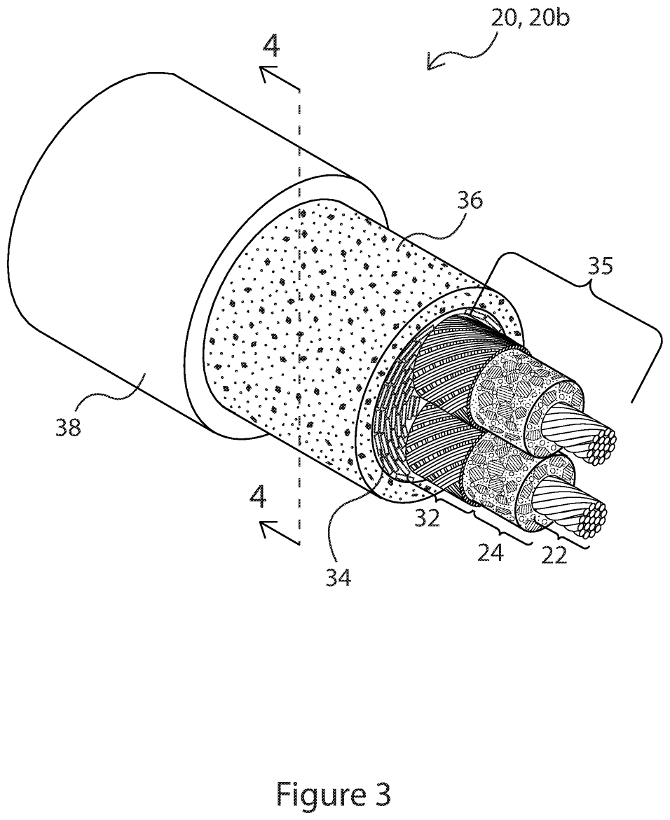

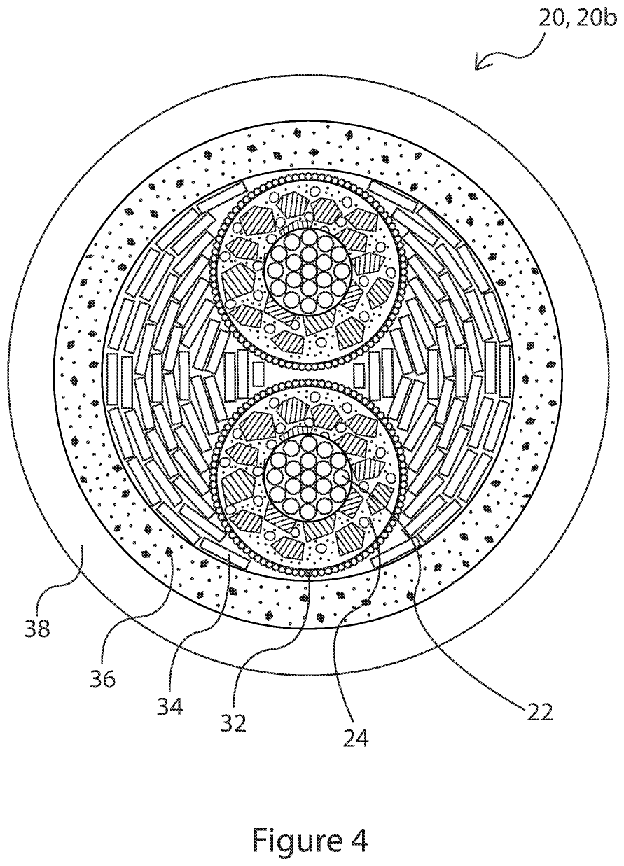

In FIGS. 3 and 4 fire resistant cable 20, 20b is a cable made up of two insulated wires 35; each wire comprises a conductor 22. Metal conductor 22 may have a plurality of conductors twisted together. Metal conductor 22 could also be a single, solid conductor. Each wire further comprises insulation layer 24 surrounding conductor 22. Insulation layer 24 may be any of the insulation layers shown in FIGS. 11a-14b and discussed below. Insulation layer is a composite material including ceramic particles 25 in a polymer matrix 30, where the ceramic particles start to sinter together at a temperature lower than the complete decomposition of the polymer chains. Each wire may further include a braided insulation layer 32. Cable 20b may further include a filler layer 34. Cable 20b may further include a fire retardant layer 36. Cable 20b may also include an outer jacket 38. Although the layers are shown in a preferred order for FIGS. 3 and 4, the order, number and type of the layers may be changed without departing from the scope of the invention.

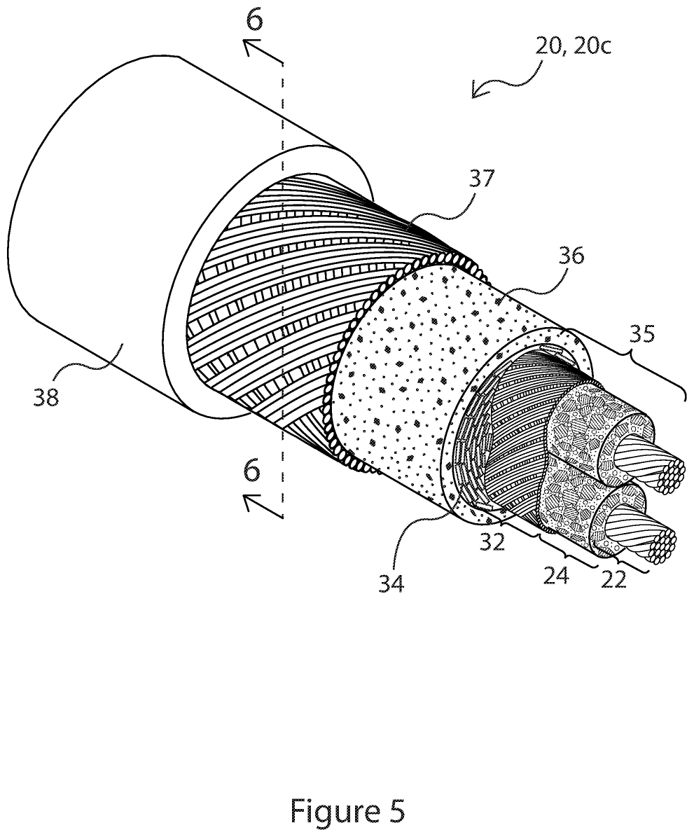

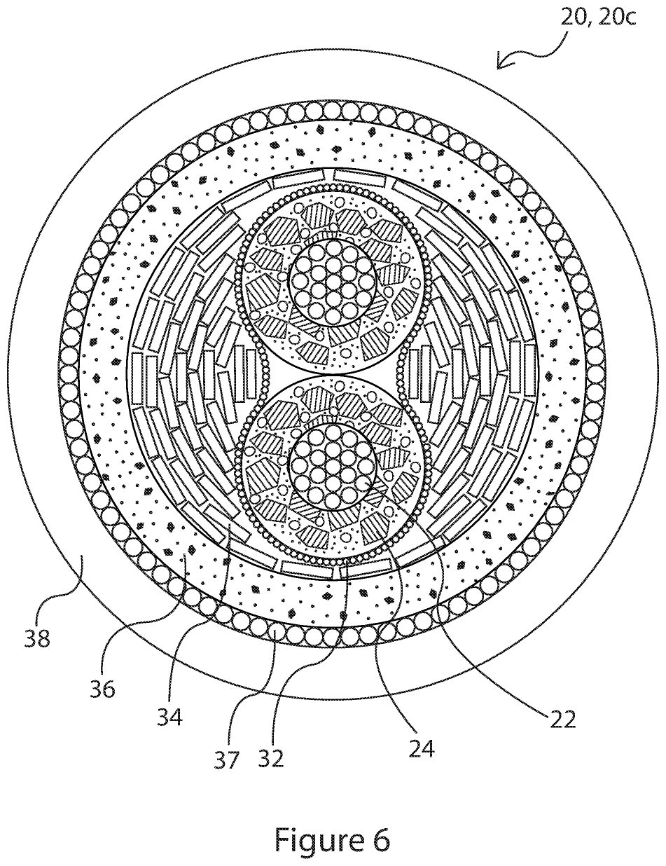

In FIGS. 5 and 6 fire resistant cable 20, 20c is a cable made up of two insulated wires 35; each wire comprises a conductor 22. Metal conductor 22 may be a plurality of conductors twisted together. Metal conductor 22 could also be a single, solid conductor. Each wire further comprises insulation layer 24 surrounding conductor 22. Insulation layer 24 may be any of the insulation layers shown in FIGS. 11a-14b and discussed below. Insulation layer is a composite material including ceramic particles 25 in a polymer matrix 30, where the ceramic particles start to sinter together at a temperature lower than the complete decomposition of the polymer chains. Each wire may further include a braided insulation layer 32. Cable 20c may further include a filler layer 34. Cable 20c may further include a fire retardant layer 36. Cable 20c may also include a braided abrasion layer 37 that is a metal wire braid. Cable 20c may also include an outer jacket 38. Although the layers are shown in a preferred order for FIGS. 5 and 6, the order, number and type of the layers may be changed without departing from the scope of the invention.

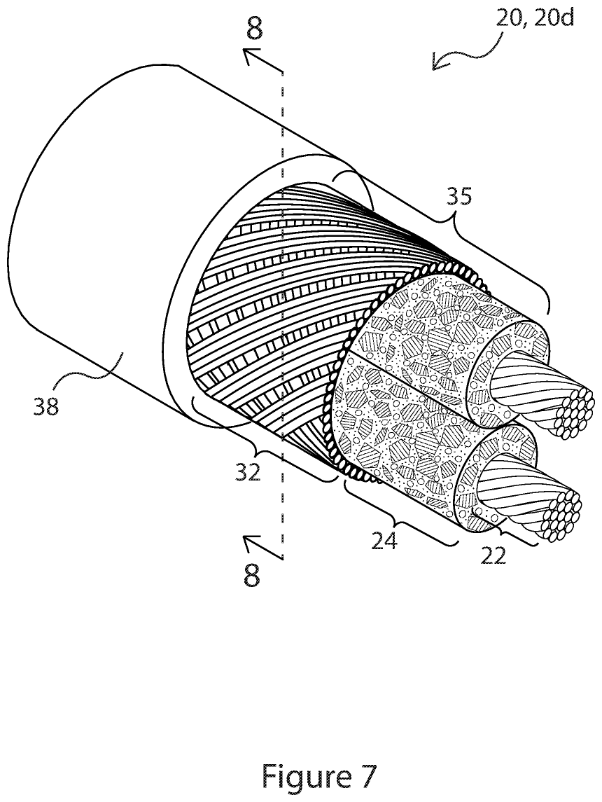

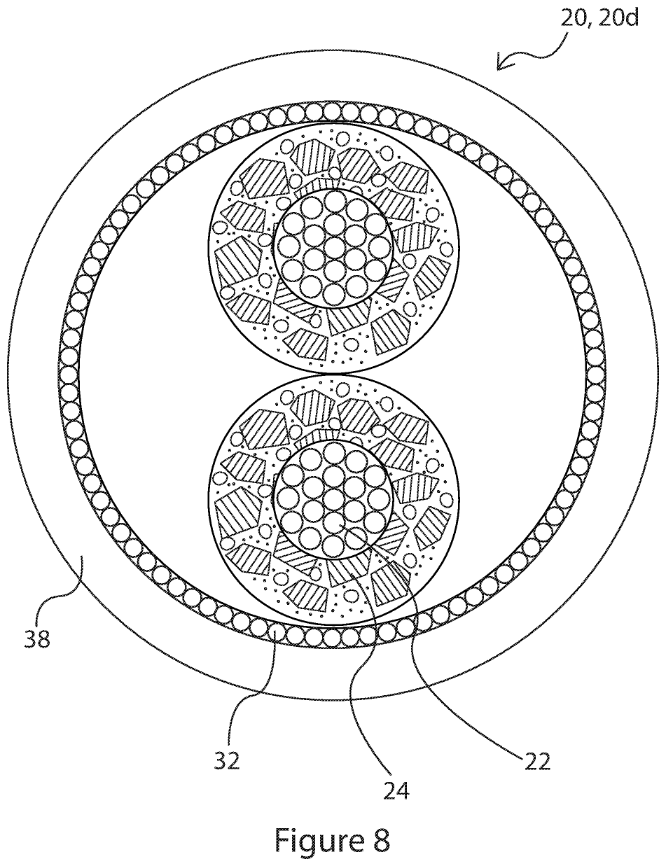

In FIGS. 7 and 8 fire resistant cable 20, 20d is a cable made up of two insulated wires 35; each wire comprises a conductor 22. Metal conductor may be a plurality of conductors twisted together. Metal conductor could also be a single, solid conductor. Each wire further comprises insulation layer 24 surrounding conductor 22. Insulation layer 24 may be any of the insulation layers shown in FIGS. 11a-14b and discussed below. Insulation layer is a composite material including ceramic particles 25 in a polymer matrix 30, where the ceramic particles start to sinter together at a temperature lower than the complete decomposition of the polymer chains. Cable 20d has two insulated wires 35. Cable 20d may further include a braided insulation layer 32 such as a woven glass tape. Cable 20d may further include an outer jacket 38.

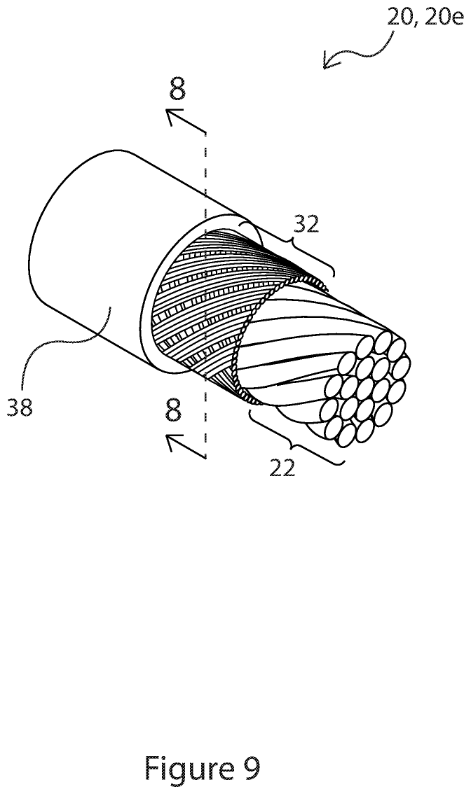

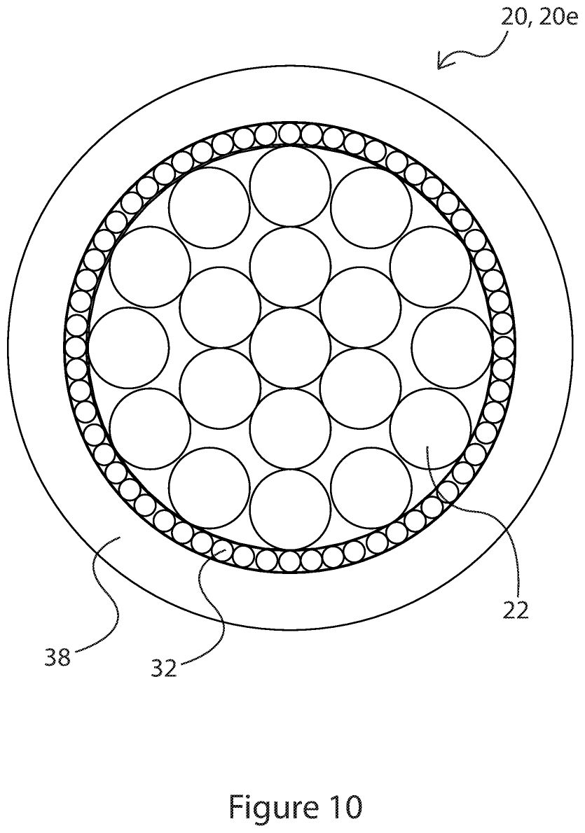

In FIGS. 9 and 10 fire resistant cable 20, 20e is a single wire. Cable 20e comprises a conductor 22. Metal conductor 22 has a plurality of conductors twisted together. Metal conductor 22 could also be a single, solid conductor. Cable 20e further comprises insulation layer 24 surrounding conductor 22. Insulation layer 24 is a woven/braided insulation layer 32 such as alumina silica fiber. Cable 20e may also include an outer jacket 38.

FIGS. 11a-14b show various ceramic/polymer composite insulation layers 24 and how these insulation layers respond when exposed to a fire. In one embodiment, FIG. 11a, insulation layer 24 comprises crystalline ceramic particles 25a and amorphous ceramic particles 25b in a polymer matrix 30. Crystalline ceramic particles 25a include at least one from the group including aluminum hydroxide, magnesium oxide and alumina oxide. Crystalline ceramic particles 25a typically have a size range of D50 diameter of 1-10 microns. Amorphous ceramic particles 25b (a.k.a. glass particles) are formed from a glass having a low glass transition temperature of around 500° C. or lower. Amorphous ceramic particles are 25b include at least one from the group including, calcium oxide, aluminum oxide, sodium oxide and silicon dioxide. Glass particles 25b typically have a size range of D50 diameter of 1-10 microns. A broad size distribution is critical to achieve a high packing density of over sixty-five percent by volume. High ceramic packing density insures a dense ceramic with numerous surfaces for bonding. In general the packing factor, as described in “Packing Spheres” by Gardner and hereby incorporated by reference, determines the amount of bonding contact points. Wide particle distributions create tighter packing factors. The packing density of particles based on the particle size distribution should amount to at least 65% of the theoretical density of the base ceramic or glass material. For example a particle size distribution range such as d10=1.0 microns, d50=4.0 microns, and d90=7 to 8 microns. Polymer matrix 30 is formed from polymer chains 28 that may be at least one from the group consisting of a polyolefin, thermoplastic elastomer, thermoplastic urethane and terpolymer. Any polymer may be used, but these work well for glasses having low glass transition temperatures of around 500° C. or lower. Additionally insulation layer 24 may include a coupling agent to enhance the loading of ceramic particles into the polymer. Coupling agents work by attaching to the surface of ceramic particles and thereby enhance loading compatibility within the polymer. Insulation layer 24 may also include polymer compatibilizers such as maleic anhydride to enhance mixing and homogenization of different polymers.

During the exposure to fire, crystalline ceramic particles 25a, glass particles 25b and polymer 28 starts to heat up. The polymer chains start to break down and volatilize. Crystalline ceramic particles 25a and glass particles 25b are brought closer together as polymer 28 volatizes. As crystalline ceramic particles 25a and glass particles 25b reach the glass transition temperature of the glass, the glass starts to wet the crystalline ceramic particles causing them to bond together. It is critical that the crystalline ceramic particles 25a start to sinter together at a temperature lower than the complete decomposition of the polymer chains. In this manner, before the complete decomposition of the polymer chains (polymer being the material holding the ceramic particles together) the crystalline ceramic and glass form a continuous, sintered ceramic, FIG. 11b, that continues to protect and support conductor 22 from the heat of the fire and extends the circuit integrity of the cable.

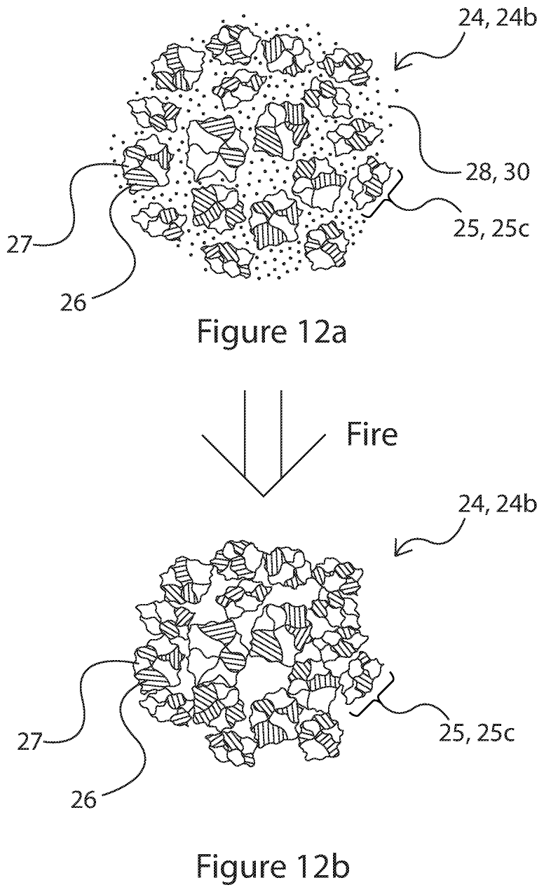

In another embodiment, FIG. 12a, insulation layer 24 comprises glass-ceramic particles 25c in a polymer matrix 30. A glass-ceramic is a ceramic with a defined chemical composition such that at a given temperature there are both crystalline regions 26 and amorphous glass regions 27 within a particle. Glass-ceramic particles 25c are typically formulated from elements such as Si, Ba, B, Al, Ca, O and may be a material such as Ferro L8. Glass-ceramic particles 25c typically have a size range of D50 diameter of 1-10 microns. A broad size distribution is critical to achieve a high packing density of over sixty-five percent. High ceramic packing density insures a dense ceramic with numerous surfaces for bonding. In general the packing factor, as described in “Packing Spheres” by Gardner, determines the amount of bonding contact points. The packing density of particles based on the particle size distribution should amount to at least 65% of the theoretical density of the base ceramic or glass material. For example a particle size distribution range such as d10=1.0 microns, d50=4.0 microns, and d90=7 to 8 microns. The polymer matrix is formed from polymer particles that are at least one from the group consisting of a polyolefin, thermoplastic elastomer, thermoplastic urethane and terpolymer. Any polymer may be used, but these work well for glasses having low glass transition temperatures of 550° C. or lower. Additionally insulation layer 24 may include a coupling agent to enhance the loading of ceramic particles into the polymer. Coupling agents work by attaching to the surface of ceramic particles and thereby enhance loading compatibility within the polymer. Insulation layer 24 may also include polymer compatibilizers such as maleic anhydride to enhance mixing and homogenization of different polymers.

During the exposure to fire, the glass-ceramic particles 25c and polymer 28 starts to heat. The polymer chains start to break down and volatilize. Glass-ceramic particles 25c are brought closer together. Glass-ceramic particles 25c are brought closer together as polymer 28 volatizes. As the glass-ceramic particles 25c reach the glass transition temperature of the glass, the glassy regions 27 within the glass-ceramic particles 25c start to bond with other glassy region and also wet crystalline ceramic regions 26 causing all glass-ceramic particles 25c to bond together. Glass-ceramic particles 25c start to sinter together at a temperature lower than the complete decomposition of the polymer chains. It is critical that glass-ceramic particles 25c start to sinter together at a temperature lower than the complete decomposition of the polymer chains. In this manner, before the complete decomposition of the polymer chains (polymer being the material holding the glass-ceramic particles 25c together) the crystalline ceramic and glass form a continuous, sintered ceramic, FIG. 12b, that continues to protect and support conductor 22 from the heat of the fire and extends the circuit integrity of the cable.

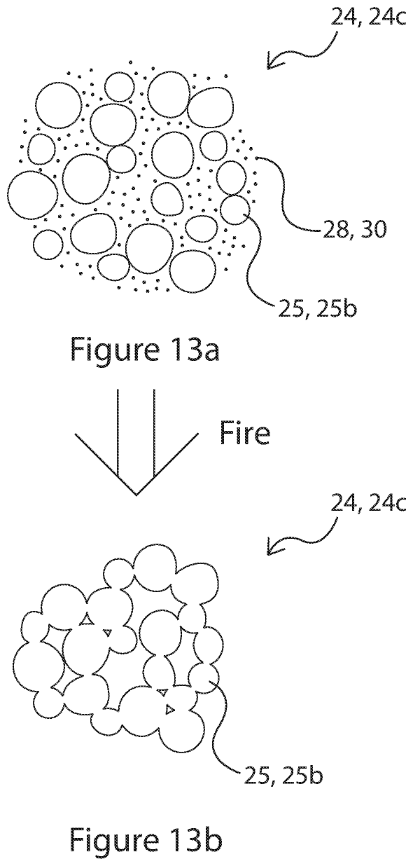

In another embodiment, FIG. 13a, insulation layer 24 comprises glass particles 25b in a polymer matrix 30. Glass particles 25b may be a material such as Elan 9013 or Ferro 640/641. Glass particles 25b typically have a size range of D50 diameter of 1-10 microns. A broad size distribution is critical to achieve a high packing density of over sixty-five percent. High ceramic packing density insures a dense ceramic with numerous surfaces for bonding. In general the packing factor, as described in “Packing Spheres” by Gardner, determines the amount of bonding contact points. Wide particle distributions create tighter packing factors. The packing density of particles based on the particle size distribution should amount to at least 65% of the theoretical density of the base ceramic or glass material. For example a particle size distribution range such as d10=1.0 microns, d50=4.0 microns, and d90=7 to 8 microns. Polymer matrix 30 is formed from polymer particles that are at least one from the group consisting of a polyolefin, thermoplastic elastomer, thermoplastic urethane and terpolymer. Any polymer may be used, but these work well for glasses having low glass transition temperatures of about 500° C. or lower. Additionally insulation layer 24 may include a coupling agent to enhance the loading of ceramic particles into the polymer. Coupling agents work by attaching to the surface of ceramic particles and thereby enhance loading compatibility within the polymer. Insulation layer 24 may also include polymer compatibilizers such as maleic anhydride to enhance mixing and homogenization of different polymers.

During the exposure to fire, glass particles 25b and polymer 28 start to heat. The polymer chains start to break down and volatilize. Glass particles 25b are brought closer together as polymer 28 volatizes. As glass particles 25b reach the glass transition temperature of the glass, the glass starts to sinter. It is critical that glass particles 25b start to sinter together at a temperature lower than the complete decomposition of the polymer chains. In this manner, before the complete decomposition of the polymer chains (polymer being the material holding the glass particles together) the glass form a structurally continuous, sintered ceramic, FIG. 13b, that continues to protect and support conductor 22 from the heat of the fire and extends the circuit integrity of the cable.

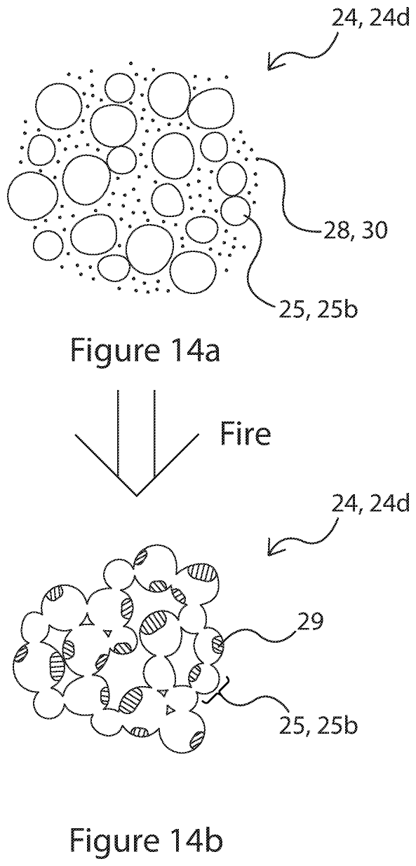

In another embodiment, FIG. 14a, insulation layer 24 comprises glass particles 25b in a polymer matrix. Glass particles 25b may include at least one from the group consisting of Mo-Sci Corp glass 1810 glass materials that starts sintering at temperatures lower than 600° C. Mo-Sci 1810 glass is designed to have good adhesion to a copper conductor after sintering. Glass particles 25b typically have a size range of D50 diameter of 1-10 microns. A broad size distribution is critical to achieve a high packing density of over sixty-five percent. High ceramic packing density insures a dense ceramic with numerous surfaces for bonding. In general the packing factor, as described in “Packing Spheres” by Gardner, determines the amount of bonding contact points. Wide particle distributions create tighter packing factors. The packing density of particles based on the particle size distribution should amount to at least 65% of the theoretical density of the base ceramic or glass material. For example a particle size distribution range such as d10=1.0 microns, d50=4.0 microns, and d90=7 to 8 microns. Polymer matrix 30 is formed from polymer particles that are at least one from the group consisting of a polyolefin, thermoplastic elastomer, thermoplastic urethane and terpolymer. Any polymer may be used, but these work well for glasses having low glass transition temperatures of about 500° C. or lower. Additionally insulation layer 24 may include a coupling agent to enhance the loading of ceramic particles into the polymer. Coupling agents work by attaching to the surface of ceramic particles and thereby enhance loading compatibility within the polymer. Insulation layer 24 may also include polymer compatibilizers such as maleic anhydride to enhance mixing and homogenization of different polymers.

During the exposure to fire, glass particles 25b and polymer 28 start to heat. The polymer chains start to break down and volatilize. Glass particles 25b are brought closer together as polymer 28 volatizes. As glass particles 25b reach the glass transition temperature of the glass, the glass starts to form crystalline nuclei 29 that provide additional strength to the insulating structure. It is critical that glass particles 25b start to sinter together at a temperature lower than the complete decomposition of the polymer chains. In this manner, before the complete decomposition of the polymer chains (polymer being the material holding the glass particles together) the glass forms a structurally connected, sintered ceramic, FIG. 14b, that continues to protect and support conductor 22 from the heat of the fire and extends the circuit integrity of the cable.

The underlying physical and chemical principles through which the transformation of insulation layer 24 (illustrated in FIGS. 11a-14b) takes place when exposed to a fire is shown in FIG. 15. The decomposition of polymer 28 is shown by the TGA curve. Simultaneous with the decomposition of polymer 28, as the polymer decomposes and volatilizes ceramic particles 25 are being brought closer together. As one reaches the glass transition temperature of ceramic particles in polymer matrix 30, the ceramic particles start to sinter together. For crystalline ceramic particles, the co-existing glass particles start to bond the crystalline ceramic particles together; for glass-ceramic particles, the glassy regions start to bond with other glassy regions and crystalline regions, and for glass particles the glass particles start to sinter together. As the ceramic particles start to bond together, they further densify and create a continuous, sintered ceramic layer that is structurally strong and that encases the conductor to shield the conductor from heat, provide additional strength to the conductor, and protect the conductor from degradation.

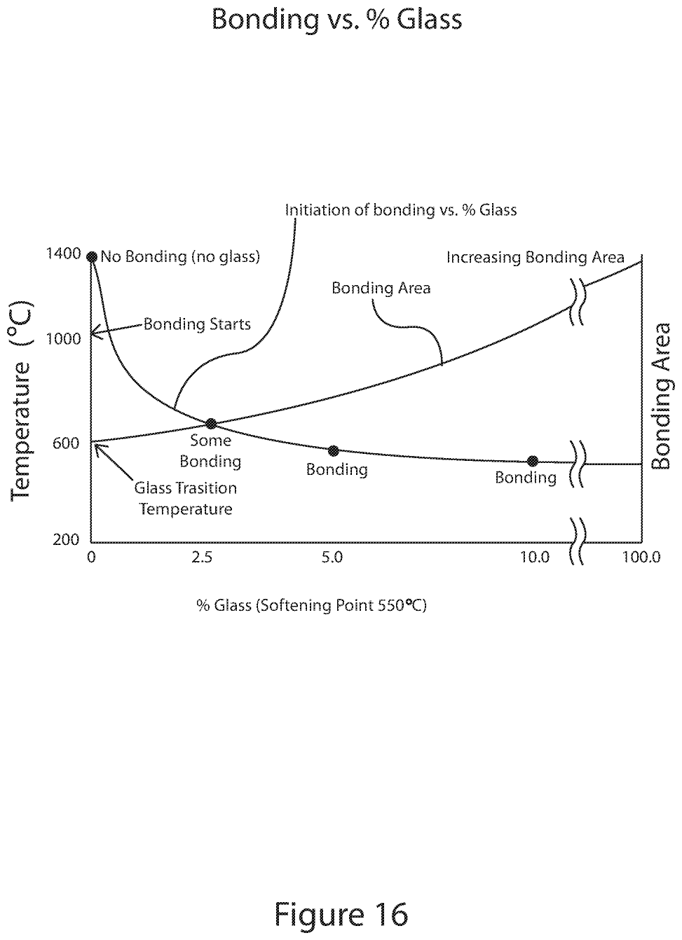

FIG. 16. is an exemplary plot of bonding area between ceramic particles as the percent of glass increase for insulation layers formed as shown in FIG. 11a-14b. Bonding starts near the glass transition temperature. The bonding area increases with the amount of amorphous glass particles combined with crystalline ceramic particles.

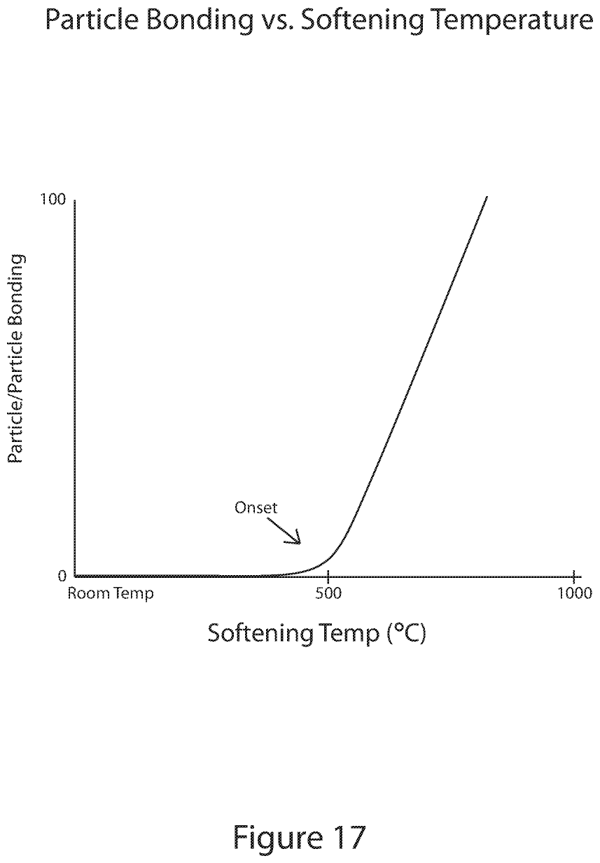

FIG. 17. is an exemplary plot of particle bonding versus softening temperature. As the temperature approaches the softening temperature, the particle/particle bonding gets stronger.

The final density of the ceramic after being exposed to heat and flame plays a role in the insulation properties of the ceramic. The ceramic has the highest thermal conductivity when the ceramic is 100% dense. In contrast, the ceramic has the lowest thermal conductivity when the ceramic has the most porosity. Therefore there is a tradeoff between having the highest possible packing density to insure there are enough ceramic surfaces to bond together to form a continuous sintered ceramic and high porosity that will provide the highest thermal insulation. Unfortunately, if there are too many pores, the insulation layer may not be continuous and spall off to leave the conductor exposed. Increased porosity may further affect thermal expansion, further leading to spalling of the ceramic particles because of a thermal coefficient mismatch with the conductor.

During exposure to a fire, polymers within the cable decompose in an oxygen depleted environment (reducing atmosphere) creating carbon particle residue. Therefore in some embodiments an inorganic oxidizer may be incorporated into insulation layer 24 (24a-24d) to help reduce carbon from forming during the thermal decomposition of the polymer particles 28 as cable 20 (20a-20d) is exposed to temperatures above 350° C. If carbon is formed during the polymer decomposition process, either from carbon particles 28 or a jacket, the carbon may impede sintering of the crystalline and amorphous ceramic particles allowing for a thermal time period in which there is reduced adhesion between the particles. By adding an oxidizer, oxygen is released during the decomposition of all polymers, which then causes the carbon to oxidize into a gas retarding the formation of carbon particles and improving sintering conditions. Oxidizers may include cerium oxide, manganese oxide, etc. These oxidizers are electrically insulative and therefore help to insure good insulative properties.

In some embodiments mixtures of the insulation layers 24 (24a-24d) shown in FIGS. 11a-14b may be combined to create insulating materials that provide improved adhesion and sintering characteristics. For example, glass particles 25b may be combined with glass ceramic particles 25c. The low temperature glass particles 25b will melt to incorporate carbon particles generated during decomposition of the polymer, thereby providing good wetting and adhesion of the glass ceramic particles 25 prior to and during the sintering of the particles glass ceramic particles 25c.

In other embodiments the outer jacket may be fabricated from materials that reduce the amount of carbon generated during a high-temperature thermal event in the range of 350° C. to 1000° C. For example, a jacket loaded with ceramic in the range of 65-75% by weight ceramic would reduce the amount of carbon generated during the high-temperature event and therefore reduce carbon production within insulation layer 24 prior to sintering of the ceramic particles.

Insulation layer 24 may be compounded with additives using a Continuous Process Mixer (CPM), Buss kneader, twin screw mixers, Banbury, etc. Added to the CPM are the polymer resins (such as EXACT 3132, Engage 8100, Levapren 900, EVA(Ethylene Vinyl Acetate), LC180, Polybond 3349, etc.), antioxidants to improve oxidation resistance (MD24), metal deactivators to sequester copper ions from migrating to the polymeric insulation, compatibilizers such as maleic anhydride (MAH) to facilitate mixing and homogenization of various polymeric components, cross linkers such as cross linker monomer from Sartormer SR350 to facilitate cross linking with E-beam irradiation, acid neutralizers such as pationic acid to sequester acid ions derived from the polymers, flame retardants, and ceramic/glass powders that have been surface treated with coupling agents to improve loading of the inorganics within the organic mixture. Ceramic/glass loadings are between 65% by weight minimum and as high as 85% by weight. Minimum loadings of 65% are critically needed to generate a structure that yields a stable structure when the polymer is gone. Broad particle size distribution is critical for maximum packing, the more particles that touch, the more bonding that can occur between those particles and hence achieve a continuous, sintered ceramic of higher strength. Also, the high packing density of ceramic particles results in a denser, stronger ceramic that supports and protects the conductor. The resins and the additives are homogeneously blended within the plastic mixer with heat in the range of 120° C.-290° C. The heated, blended mix is then pelletized under water to make ⅛″ size pellets. The pellets are centrifuged and dried.

Fire resistant cable 24 may be fabricated as follows. An elongated conductor such as copper 8-16 AWG (128-51 mils diameter) is provided; however any gauge conductor may be used. Insulation material in the form of dried pellets is then introduced into an extruder, such as a Davis standard single screw in the temperature range 120-175° C., and extruded over the outside of the conductor. A layer of insulating compound is applied to surround the conductor. The insulation thickness is determined by the UL and other specs. The extruded insulated wire passes through a trough of water to quench the polymer and is then spooled onto various size spools depending on the diameter of the cable. The conductor and applied insulating compound are then irradiated to promote crosslinking of the polymers. E-beam energy dosages of 90-220 kilo grays are used at voltages in the range of 800,000 to 1.5 million volts. The dosage controls the cross linking and the voltage is for penetration based on the thickness of the cable polymer. This irradiation strengthens the insulation layer as the insulation layer is now cross linked. In some formulations crosslinking of the polymers may not be needed because the high loading of the ceramic particles already creates a strong insulation layer. Once the primary (conductor and insulation layer) is irradiated the next step is cabling. Here metal or ceramic yarn is added to cover about 60% of outer surface area. These primaries are either left as straight insulated wire or have a plurality twisted together. Additional layers such as fillers, flame retardant layers and the jacket goes on top of the cabled core and has ingredients such as

Alternative techniques for applying insulation layer 24 to conductor 22 are as follows. The insulation layer may be applied to the conductor drawing the conductor through a solvent based slurry followed by curing in an oven. The insulation layer may be a thermally sprayed insulation layer around the electrical conductor. The insulation layer may be applied as a wrapped ceramic particle filled tape around the conductor,

Insulation layer 24 may be fabricated as thin as 12 mils. A continuous insulation layer can be form at this thin thicknesses because of the high loading of the ceramic particles.

Additional layers may be provided over the extruded insulation layer 24 and conductor 22 to further enhance the insulation, electrical, wear properties and overall structural integrity of cable 20. For example, Zircar alumina silica yarn that can be braided using a Wardwell Braiding Machine over insulation layer 24 to add additional insulation and mechanical strength. A bedding flame retardant compound (such as manufactured by Gendon) may then be extruded to add further flame retardant properties to the cable. As a final layer, an extruded polyolefin based jacket may be extruded over the bedding layer to improve wear and aesthetics of the final cable 20.

Examples of the aforementioned embodiments are disclosed in the following non-limitative examples.

### EXAMPLE 1

Insulation layer 24 was formed as a compound comprising the materials listed in TABLE 1. This formulation correlates with glass-ceramic particles sintering as shown in FIGS. 12a and 12b.

TABLE 1
Insulation Material Formulation #1

| Material | Brand Formulation | PPH* | Manufacturer |
|---|---|---|---|
| Polymer Resin A | EVA 500 | 56 | ArlanXeo |
| Polymer Resin B | EVA 700 | 19 | ArlanXeo |
| Polymer Resin C | LC180 | 19 | LG Plastics |
| Polymer Resin D | Polybond 3349 | 6 | SI Group |
| Ceramic/Glass | Ferro L8 | 245 | Ferro |
| (Surface Treated) | | | |
| Acid Neutralizer | Pationic Acid | 0.04 | Carbion |
| Cross Linking Monomer | Sartomer 350 | 4.5 | Addivant |
| Metal Deactivator | MD24 | 0.2 | Addivant |
| Antioxidant | Anox 330 | 0.1 | SI Group |

*PPH is Parts Per Hundred of Polymer

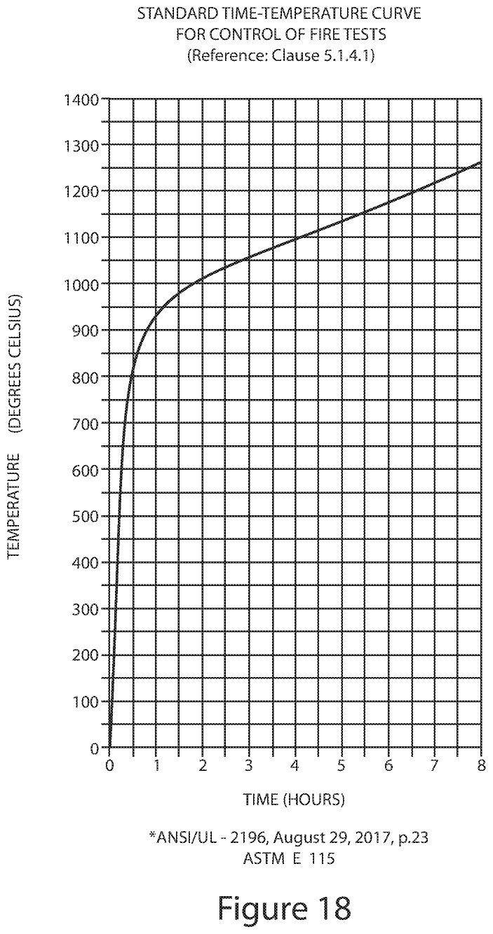

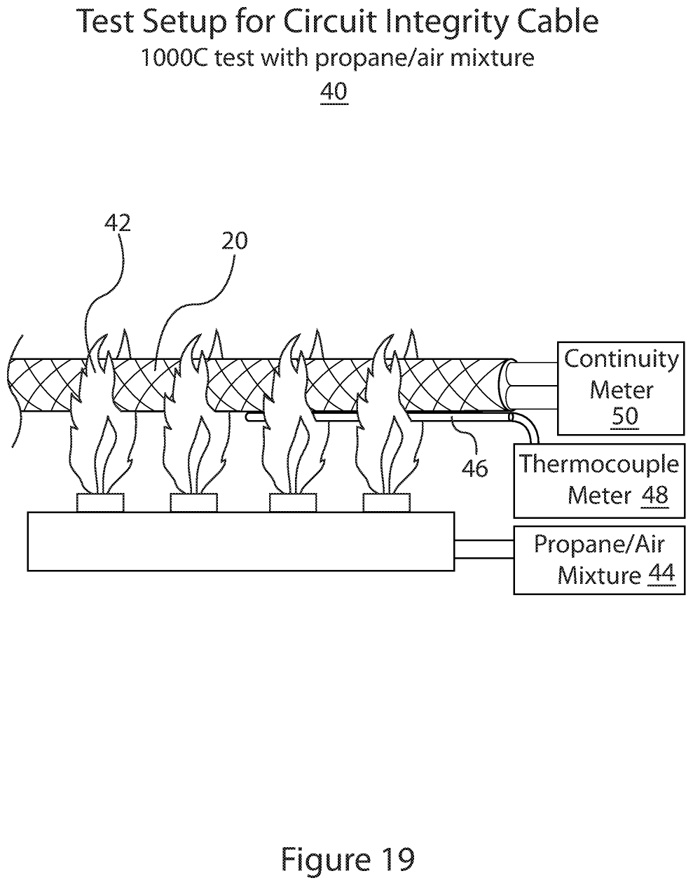

The cable in EXAMPLE 1 was exposed to a thermal excursion to 1000° C. for 2-hours as prescribed by safety test UL 2196, FIG. 18. The experimental circuit integrity setup 40 is shown in FIG. 19. In the setup, cable 20 is subjected to flames 42 generated by a propane air mixture 44. Thermocouple 46 measures the temperature of cable 20, which is recorded via a thermocouple meter 48. Continuity meter 50 is connected to the determine continuity of the electrical cable during the test. Test results showed the cable in EXAMPLE 1 maintained structural integrity after exposer to the 1000° C. temperatures for 2-hours.

### EXAMPLE 2

Insulation layer 24 was formed as a compound comprising the materials listed in TABLE 2. This formulation correlates with glass particles sintering as shown in FIGS. 14a and 14b.

TABLE 2
Insulation Material Formulation #2

| Material | Brand Formulation | PPH* | Manufacturer |
|---|---|---|---|
| Polymer Resin A | EVA 500 | 56 | ArlanXeo |
| Polymer Resin B | EVA 700 | 19 | ArlanXeo |
| Polymer Resin C | LC180 | 19 | LG Plastics |
| Polymer Resin D | Polybond 3349 | 6 | SI Group |
| Ceramic/Glass | Mo-Sci 1810 | 245 | Mo-Sci Corp. |
| (Surface Treated) | | | |
| Acid Neutralizer | Pationic Acid | 0.04 | Carbion |
| Cross Linking Monomer | Sartomer 350 | 4.5 | Addivant |
| Metal Deactivator | MD24 | 0.2 | Addivant |
| Antioxidant | Anox 330 | 0.1 | SI Group |

*PPH is Parts Per Hundred of Polymer

The cable in EXAMPLE 2 was exposed to a thermal excursion to 1000° C. for 2-hours as prescribed by safety test UL 2196, FIG. 18. The experimental circuit integrity setup 40 is shown in FIG. 19 and described in EXAMPLE 1 above. The test results showed the cable in EXAMPLE 2 maintained structural integrity after exposer to the 1000° C. temperature for 2-hours.

While several embodiments of the invention, together with modifications thereof, have been described in detail herein and illustrated in the accompanying drawings, it will be evident that various further modifications are possible without departing from the scope of the invention. The scope of the claims should not be limited by the preferred embodiments set forth in the examples, but should be given the broadest interpretation consistent with the description as a whole.

What is claimed is:

1) An fire resistant electrical cable, comprising:
a) an electrical conductor;
b) an insulation layer, wherein the insulation layer is a composite material including ceramic particles in a polymer matrix; and
c) wherein the polymer is comprised of polymer chains, wherein the ceramic particles start to sinter together at a temperature lower than complete decomposition of the polymer chains.

2) The fire resistant electrical cable as recited in claim 1, wherein the complete decomposition of the polymer chains is defined by no more weight loss with continued exposure to heat.

3) The fire resistant electrical cable as recited in claim 1, wherein the ceramic particles are a mixture of crystalline ceramic particles and amorphous ceramic particles.

4) The fire resistant electrical cable as recited in claim 3, wherein the crystalline ceramic particles are at least one from the group consisting of aluminum hydroxide, magnesium oxide, calcium oxide and silicon dioxide.

5) The fire resistant electrical cable as recited in claim 3, wherein the amorphous ceramic particles have a glass transition temperature of 500° C. or lower.

6) The fire resistant electric cable as recited in claim 3, wherein the ceramic particles are glass-ceramic particles.

7) The fire resistant electrical cable as recited in claim 1, wherein the sintering temperature is in the range of 500° C. to 600° C.

8) The fire resistant electrical cable as recited in claim 1, wherein the ceramic particles are greater than 65-percent by weight.

9) The fire resistant electrical cable as recited in claim 1, wherein the polymer particles is at least one from the group consisting of a polyolefin, thermoplastic elastomer, thermoplastic urethane and terpolymer.

10) The fire resistant electrical cable as recited in claim 1, wherein the ceramic particles have a D50 diameter in the range 1 to 10 microns.

11) The fire resistant electrical cable as recited in claim 1, wherein the ceramic particles have a broad particle size distribution allowing for greater than 65-percent packing.

12) The fire resistant electrical cable as recited in claim 1, wherein the insulation layer is an extruded insulation layer around the electrical conductor.

13) The fire resistant electrical cable as recited in claim 1, wherein the insulation layer is slurry drawn insulation layer around the electrical conductor.

14) The fire resistant electrical cable as recited in claim 1, wherein the insulation layer is a thermally sprayed insulation layer around the electrical conductor.

15) The fire resistant electrical cable as recited in claim 1, further comprising a braided layer of alumina-silica filament woven around the metal conductor and insulation layer.

16) The fire resistant electrical cable as recited in claim 1, further comprising a char forming layer surrounding the metal conductor and insulation layer.

17) The fire resistant electrical cable as recited in claim 1, further comprising a bedding layer surrounding the metal conductor and insulation layer.

18) The fire resistant electrical cable as recited in claim 1, further comprising an outer jacket surrounding the metal conductor and insulation layer.

19) The fire resistant electrical cable as recited in claim 1, wherein the ceramic particles are an amorphous ceramic.

20) The fire resistant electrical cable as recited in claim 19, wherein the amorphous ceramic particles have a glass transition temperature of 500° C. or lower.

21) The fire resistant electrical cable as recited in claim 1, wherein the insulation layer is halogen free.

22) The fire resistant electrical cable as recited in claim 1, wherein the insulation layer includes an inorganic oxidizer.

23) The fire resistant electrical cable as recited in claim 1, wherein the cable maintains structural integrity when exposed to 1000° C. for at least 2-hours.

24) A fire-resistant composite material, comprising:
a) ceramic particles;
b) the remainder of the material being substantially a polymer; and
c) wherein the polymer is comprised of polymer chains, wherein the ceramic particles start to sinter together at a temperature lower than complete decomposition of the polymer chains.

25) The fire resistant electrical cable as recited in claim 24, wherein the complete decomposition of the polymer chains is defined by no more weight loss with continued exposure to heat.

26) The material as recited in claim 24, wherein the ceramic particles are a mixture of crystalline ceramic particles and amorphous ceramic particles.

27) The material as recited in claim 24, wherein the crystalline ceramic particles are at least one from the group consisting of aluminum hydroxide, magnesium oxide, calcium oxide and silicon dioxide.

28) The material as recited in claim 24, wherein the amorphous ceramic particles have a glass transition temperature of 500° C. or lower.

29) The material as recited in claim 24, wherein the ceramic particles are glass-ceramic particles.

30) The material as recited in claim 24, wherein the sintering temperature is in the range of 550° C. to 650° C.

31) The material as recited in claim 24, wherein the ceramic particles are greater than 65-percent by weight.

32) The material as recited in claim 24, wherein the polymer particles is at least one from the group consisting of a polyolefin, thermoplastic elastomer, thermoplastic urethane and terpolymer.

33) The material as recited in claim 24, wherein the ceramic particles have a D50 diameter in the range 1 to 10 microns.

34) The material as recited in claim 24, wherein the ceramic particles have a broad particle size distribution allowing for greater than 65-percent packing.

35) The material as recited in claim 24, further including a coupling agent.

36) The material as recited in claim 24, further including an inorganic oxidizer.

37) The material as recited in claim 24, wherein the ceramic particles are an amorphous ceramic.

38) The material as recited in claim 37, wherein the amorphous ceramic particles have a glass transition temperature of 500° C. or lower.

39) The material as recited in claim 24, wherein the polymer does not convert to ceramic upon when exposed to a flame.

40) A method of extending the circuit integrity of an electrical conductor, comprising:
a) providing an electrical conductor;
b) surrounding the electrical conductor with an insulation layer that includes ceramic particles within a polymer matrix, the polymer matrix being comprised of polymer chains; and
c) whereby when exposed to a fire the ceramic particles start to sinter together prior to complete decomposition of the polymer chains forming a continuous, sintered ceramic that thermally insulates the electrical conductor.

41) The method as recited in claim 40, wherein the ceramic particles are at least one from the group consisting of crystalline ceramic particles and amorphous ceramic particles.

42) The method as recited in claim 40, further comprising braiding a layer of alumina-silica filament woven around the metal conductor and insulation layer.

43) The method as recited in claim 40, further comprising surrounding the electrical conductor and insulation layer with a char producing material.

44) The fire resistant electrical cable as recited in claim 40, further comprising surrounding the metal conductor and insulation layer with a bedding layer.

45) The fire resistant electrical cable as recited in claim 40, further comprising surrounding the metal conductor and insulation layer with an outer jacket.

46) A fire resistant electrical cable, comprising:
a) an electrical conductor; and
b) a braided layer of alumina-silica filament woven around the metal conductor.
